(19) United States
(12) Patent Application Publication
(10) Pub. No.: US 2023/0081747 A1
(43) Pub. Date: Mar. 16, 2023

(54) HIGH DENSITY FIBER INTERFACES FOR SILICON PHOTONICS BASED INTEGRATED-OPTICS PRODUCTS

(71) Applicant: Cisco Technology, Inc., San Jose, CA (US)

(72) Inventors: Subal SAHNI, La Jolla, CA (US); Peter M.C. DE DOBBELAERE, San Diego, CA (US); Michael P. MACK, San Diego, CA (US)

(21) Appl. No.: 17/447,886

(22) Filed: Sep. 16, 2021

(51) Int. Cl. G02B 6/34; G02B 6/12; G02B 6/124

(52) U.S. Cl. CPC G02B 6/34; G02B 6/12004; G02B 6/12007; G02B 6/124; G02B 2006/12102; G02B 2006/12061; G02B 2006/12114; G02B 2006/12111; G02B 2006/12147; G02B 2006/12107

(57) ABSTRACT

High density fiber interfaces for silicon photonics based integrated-optics products are provided via a system or device that includes: a prism configured to reflect, via a lensed reflecting surface, a plurality of optical signals between a first surface and a second surface at a non-normal angle of incidence; a photonic interposer including a plurality of grating couplers corresponding to the plurality of optical signals that are arranged in a two-dimensional array and that are optically connected directly to the first surface of the prism; and a plurality of optical fibers that are arranged in the two-dimensional array and that are optically connected directly to the second surface of the prism.

### TECHNICAL FIELD

Embodiments of the present disclosure relate to electronic components. More specifically, certain implementations of the present disclosure relate to methods and systems for CWDM MUX/DEMUX designs for silicon photonic interposers.

### BACKGROUND

Conventional approaches for multiplexing and demultiplexing may be costly, cumbersome, and/or inefficient—e.g., they may be complex and/or time consuming, and/or may have limited responsivity due to losses.

Further limitations and disadvantages of conventional and traditional approaches will become apparent to one of skill in the art, through comparison of such systems with some aspects of the present disclosure as set forth in the remainder of the present application with reference to the drawings.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 is a block diagram of a photonically-enabled integrated circuit with polarization independent MUX/DEMUX, in accordance with an example embodiment of the disclosure.

FIGS. 2A-2F illustrate side views of a high density fiber interface for silicon photonics based integrated-optics products with a two-dimensional array of integrated optics, according to example embodiments of the disclosure.

FIGS. 3A and 3B illustrate isometric views of the high density fiber interface, according to an example embodiments of the disclosure.

FIGS. 4A and 4B illustrate a surface view of portions of a silicon photonic that the high density fiber interface optically couples with, according to example embodiments of the disclosure

FIG. 5 is a schematic illustrating a MUX/DEMUX with thin film filters, in accordance with an example embodiment of the disclosure.

FIG. 6 illustrates an optical transceiver with a spatial separation beam splitter, in accordance with an example embodiment of the disclosure.

FIG. 7 illustrates an architecture with distributed MUX/DEMUX function, in accordance with an example embodiment of the disclosure.

FIG. 8 illustrates details of an external multiplexer/demultiplexer, in accordance with an example embodiment of the disclosure.

FIG. 9 illustrates a side view of an external multiplexer/demultiplexer, in accordance with an example embodiment of the disclosure.

FIG. 10 illustrates a top view and beam paths of an external multiplexer/demultiplexer, in accordance with an example embodiment of the disclosure.

FIG. 11 illustrates an isometric view of the external multiplexer/demultiplexer, in accordance with an example embodiment of the disclosure.

FIG. 12 illustrates the scaling capability of an external multiplexer/demultiplexer, in accordance with an example embodiment of the disclosure.

FIG. 13 illustrates a broadband angled fiber grating coupler, in accordance with an example embodiment of the disclosure.

FIG. 14 illustrates an on-chip two-channel multiplexer/demultiplexer, in accordance with an example embodiment of the disclosure.

FIG. 15 is a flowchart of a method of optical signaling in the high density fiber interface and silicon photonic, according to an example embodiment of the disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

System and methods are provided for CWDM MUX/DEMUX designs for silicon photonic interposers, substantially as shown in and/or described in connection with at least one of the figures, as set forth more completely in the claims.

These and other advantages, aspects and novel features of the present disclosure, as well as details of an illustrated embodiment thereof, will be more fully understood from the description and drawings.

One embodiment presented provides a system, comprising: a prism configured to reflect, via a lensed reflecting surface, a plurality of optical signals between a first surface and a second surface at a non-normal angle of incidence; a photonic interposer including a plurality of grating couplers corresponding to the plurality of optical signals that are arranged in a two-dimensional array and that are optically connected directly to the first surface of the prism; and a plurality of optical fibers that are arranged in the two-dimensional array and that are optically connected directly to the second surface of the prism.

One embodiment presented provides an optical device, comprising: a photonic interposer including a plurality of grating couplers arranged according to a two-dimensional array and configured to receive a plurality of optical signals at a given angle of reception; a prism including a reflecting surface configured to reflect the plurality of optical signals between a first surface and a second surface at a non-normal angle of incidence associated with the given angle of reception, wherein the prism is optically connected directly to the photonic interposer; a fiber interface including a plurality of optical fibers arranged according to the two-dimensional array; and a fiber lens array, connected between the fiber interface and the prism, including a plurality of fiber lenses corresponding to the plurality of optical fibers, wherein each fiber lens of the plurality of fiber lenses is located at an optical center of a corresponding beam path between the plurality of optical fibers and the plurality of grating couplers.

One embodiment presented provides an optical device, comprising: a photonic interposer including a plurality of grating couplers arranged according to a two-dimensional array and configured to receive a plurality of optical signals at a given angle of reception; a prism including a reflecting surface configured to reflect the plurality of optical signals between a first surface and a second surface at a non-normal angle of incidence associated with the given angle of reception; a fiber interface including a plurality of optical fibers arranged according to the two-dimensional array, wherein the fiber interface is optically connected directly to the prism; and a fiber lens array, connected between the prism and the photonic interposer, including a plurality of fiber lenses corresponding to the plurality of grating couplers, wherein each fiber lens of the plurality of fiber lenses is located at an optical center of a corresponding beam path between the plurality of optical fibers and the plurality of grating couplers.

### EXAMPLE EMBODIMENTS

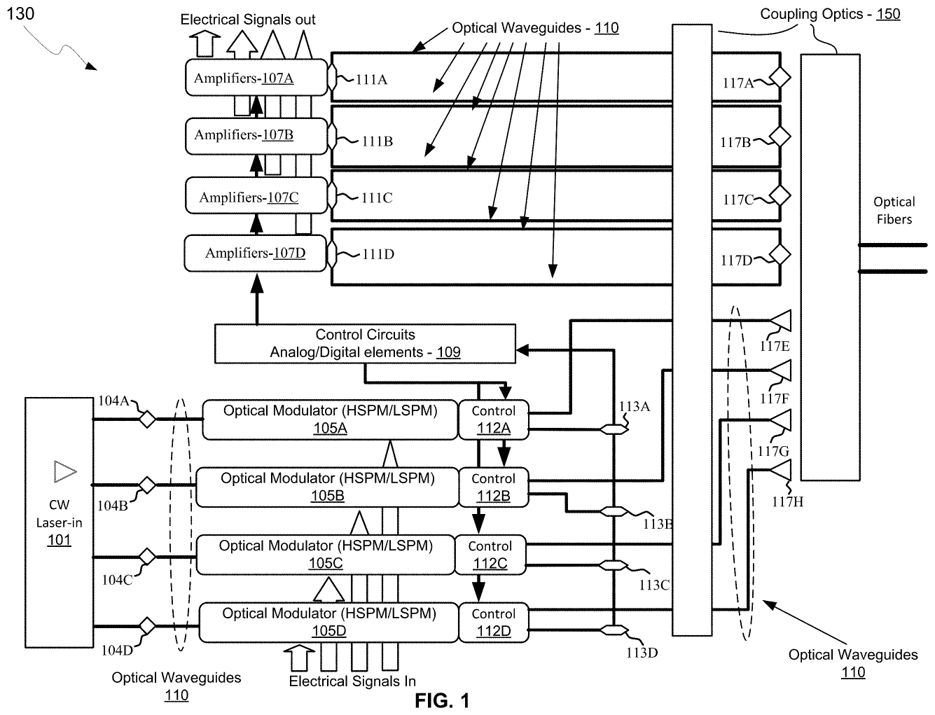

FIG. 1 is a block diagram of a photonically-enabled integrated circuit with course wavelength division multiplexing (“CWDM”) multiplexer/demultiplexer (“MUX/DEMUX”) designs for silicon photonic interposers, in accordance with an example embodiment of the disclosure. Referring to FIG. 1, there are shown optoelectronic devices of a photonically-enabled integrated circuit 130 comprising optical modulators 105A-105D, photodetectors 111A-111D (e.g. photodiodes), monitor photodetectors 113A-113D (e.g., photodiodes), and optical devices comprising couplers 103A-103C and grating couplers 117A-117H. There are also shown electrical devices and circuits comprising amplifiers 107A-107D, analog and digital control circuits 109, and control sections 112A-112D. The amplifiers 107A-107D may comprise transimpedance and limiting amplifiers (TIA/LAs), for example. Coupling optics 150 may comprise beam splitters, thin film filters, mirrors, prisms, etc., and may be integrated on the interposer as wells as external to the interposer.

In an example scenario, the photonically-enabled integrated circuit 130 comprises one or more complementary metal-oxide semiconductor (CMOS) electronics die coupled to a CMOS photonic interposer die with a laser assembly 101 also coupled to the top surface of the interposer. The laser assembly 101 may comprise one or more semiconductor lasers with isolators, lenses and or waveguide(s), such as optical fibers, and/or rotators for directing one or more continuous-wave (CW) optical signals to the couplers 104A-104D. The CW optical signals may be at different wavelengths for CWDM operation, such as CWDM4, for example. The photonically enabled integrated circuit 130 may be integrated on a plurality of die, such as with one or more electronics die and one or more photonics die.

The grating couplers 104A-104D comprise grating structures with grating spacing and width configured to couple optical signals of a specific wavelength and polarization into the IC 130. A lens array or a single lens may be incorporated between the grating couplers 104A-104D and the laser assembly 101 for focusing of the optical signal to the grating couplers for increased coupling efficiency.

Optical signals are communicated between optical and optoelectronic devices via optical waveguides 110 fabricated in the photonically-enabled integrated circuit 130. Single-mode or multi-mode waveguides may be used in photonic integrated circuits. Single-mode operation enables direct connection to optical signal processing and networking elements. The term “single-mode” may be used for waveguides that support a single mode for each of the two polarizations, transverse-electric (TE) and transverse-magnetic (TM), or for waveguides that are truly single mode and only support one mode. Such one mode may have, for example, a polarization that is TE, which comprises an electric field parallel to the substrate supporting the waveguides. Two typical waveguide cross-sections that are utilized comprise strip waveguides and rib waveguides. Strip waveguides typically comprise a rectangular cross-section, whereas rib waveguides comprise a rib section on top of a waveguide slab. Of course, other waveguide cross section types are also contemplated and within the scope of the disclosure.

The optical modulators 105A-105D comprise Mach-Zehnder or ring modulators, for example, and enable the modulation of the continuous-wave (CW) laser input signals. The optical modulators 105A-105D may comprise high-speed and low-speed phase modulation sections and are controlled by the control sections 112A-112D. The high-speed phase modulation section of the optical modulators 105A-105D may modulate a CW light source signal with a data signal. The low-speed phase modulation section of the optical modulators 105A-105D may compensate for slowly varying phase factors such as those induced by mismatch between the waveguides, waveguide temperature, or waveguide stress and is referred to as the passive phase, or the passive biasing of the MZI.

In an example scenario, the high-speed optical phase modulators may operate based on the free carrier dispersion effect and may demonstrate a high overlap between the free carrier modulation region and the optical mode. High-speed phase modulation of an optical mode propagating in a waveguide is the building block of several types of signal encoding used for high data rate optical communications. Speed in the tens of Gb/s may be used to sustain the high data rates used in modern optical links and can be achieved in integrated Si photonics by modulating the depletion region of a PN junction placed across the waveguide carrying the optical beam. In order to increase the modulation efficiency and minimize the loss, the overlap between the optical mode and the depletion region of the PN junction is carefully optimized.

One output of each of the optical modulators 105A-105D may be optically coupled via the waveguides 110 to the grating couplers 117E-117H. The other outputs of the optical modulators 105A-105D may be optically coupled to monitor photodiodes 113A-113D to provide a feedback path. The IC 130 may utilize waveguide based optical modulation and receiving functions. Accordingly, the receiver may employ an integrated waveguide photo-detector (PD), which may be implemented with epitaxial germanium/SiGe films deposited directly on silicon, for example.

The grating couplers 104A-104D and 117A-117H may comprise optical gratings that enable coupling of light into and out of the photonically-enabled integrated circuit 130. The grating couplers 117A-117D may be utilized to couple light received from optical fibers into the photonically-enabled integrated circuit 130, and the grating couplers 117E-117H may be utilized to couple light from the photonically-enabled integrated circuit 130 into optical fibers. The grating couplers 104A-104D and 117A-117H may comprise single polarization grating couplers (SPGC) and/or polarization splitting grating couplers (PSGC). In instances where a PSGC is utilized, two input, or output, waveguides may be utilized, as shown for grating couplers 117A-117D, although these may instead be SPGCs.

The optical fibers may be epoxied, for example, to the CMOS interposer, using a fiber coupler that selectively directs optical signals of different wavelengths to and from different grating couplers on the photonically-enabled integrated circuit 130, with each coupler, such as each of the grating couplers 117A-117H being configured to couple optical signals of different wavelengths.

The photodetectors 111A-111D (e.g., photodiodes) may convert optical signals received from the grating couplers 117A-117D into electrical signals that are communicated to the amplifiers 107A-107D for processing. In another embodiment of the disclosure, the photodetectors 111A-111D may comprise high-speed heterojunction phototransistors, for example, and may comprise germanium (Ge) in the collector and base regions for absorption in the 1.3-1.6 □m optical wavelength range, and may be integrated on a CMOS silicon-on-insulator (SOI) wafer.

The analog and digital control circuits 109 may control gain levels or other parameters in the operation of the amplifiers 107A-107D, which may then communicate electrical signals off the photonically-enabled integrated circuit 130. The control sections 112A-112D comprise electronic circuitry that enables modulation of the CW laser light received from the grating couplers 104A-104D. The optical modulators 105A-105D may require high-speed electrical signals to modulate the refractive index in respective branches of a Mach-Zehnder interferometer (MZI), for example.

In operation, the photonically-enabled integrated circuit 130 may be operable to transmit and/or receive and process optical signals. Optical signals may be received from optical fibers by the grating couplers 117A-117D and converted to electrical signals by the photodetectors 111A-111D (e.g., photodiodes). The electrical signals may be amplified by transimpedance amplifiers in the amplifiers 107A-107D, for example, and subsequently communicated to other electronic circuitry, not shown, in the photonically-enabled integrated circuit 130.

Integrated photonics platforms allow the full functionality of an optical transceiver to be integrated on a single chip or a plurality of chips in a flip-chip bonded structure. An optical transceiver contains optoelectronic circuits that create and process the optical/electrical signals on the transmitter (Tx) and the receiver (Rx) sides, as well as optical interfaces that couple the optical signals to and from a fiber. The signal processing functionality may include modulating the optical carrier, detecting the optical signal, splitting or combining data streams, and multiplexing or demultiplexing data on carriers with different wavelengths.

An important commercial application of silicon photonics is high speed optical transceivers, i.e., ICs that have optoelectronic transmission (Tx) and receiving (Rx) functionality integrated in the same chip or a plurality of bonded chips in a small package. The input to such an IC or ICs is either a high speed electrical data-stream that is encoded onto the Tx outputs of the chip by modulating the light from a laser or an optical data-stream that is received by integrated photo-detectors and converted into a suitable electrical signal by going through a Trans-impedance Amplifier (TIA)/Limiting Amplifier (LA) chain. Such silicon photonics transceiver links have been successfully implemented at baud-rates in the tens of GHz.

One method for increasing data rates in optical transceivers is to multiplex a plurality of optical signals at different wavelengths for concurrent transmission through the optical fiber, which may then be demultiplexed at the receiving end. To this end, multiplexers and demultiplexers may be utilized to respectively combine and separate the different optical wavelengths. This may be accomplished with thin film filters (TFFs) tuned to different wavelengths, deflecting optical signals down to near-normal incidence on the chip into corresponding grating couplers while allowing other wavelength signals to pass through. These structures are shown in FIG. 1 as coupling optics 150 and in further detail with respect to the other FIGS.

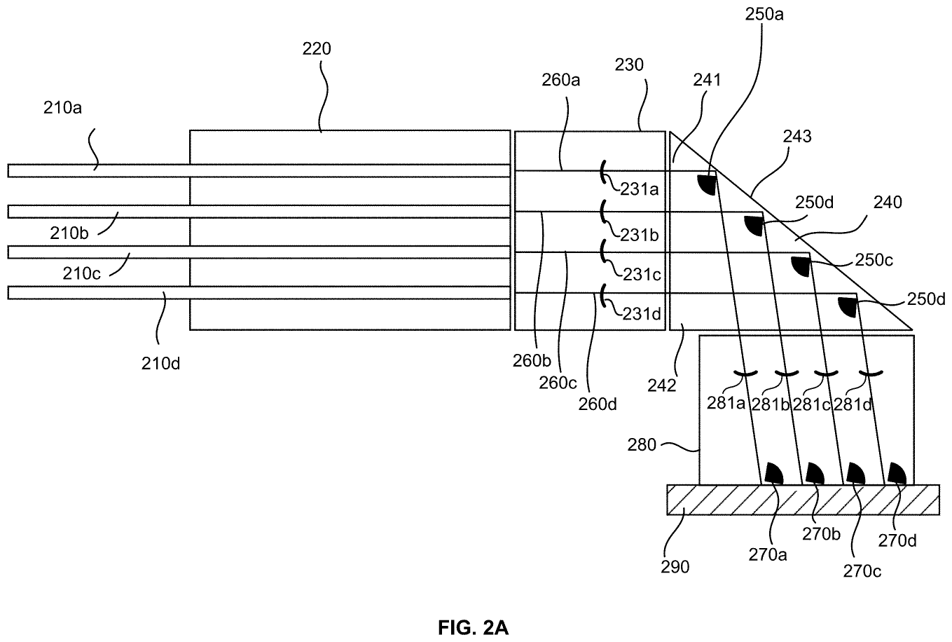

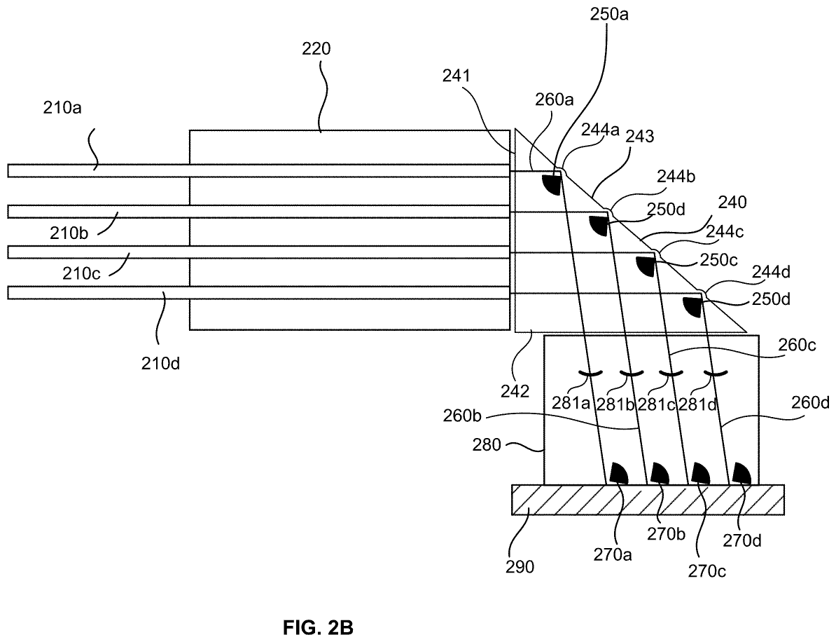

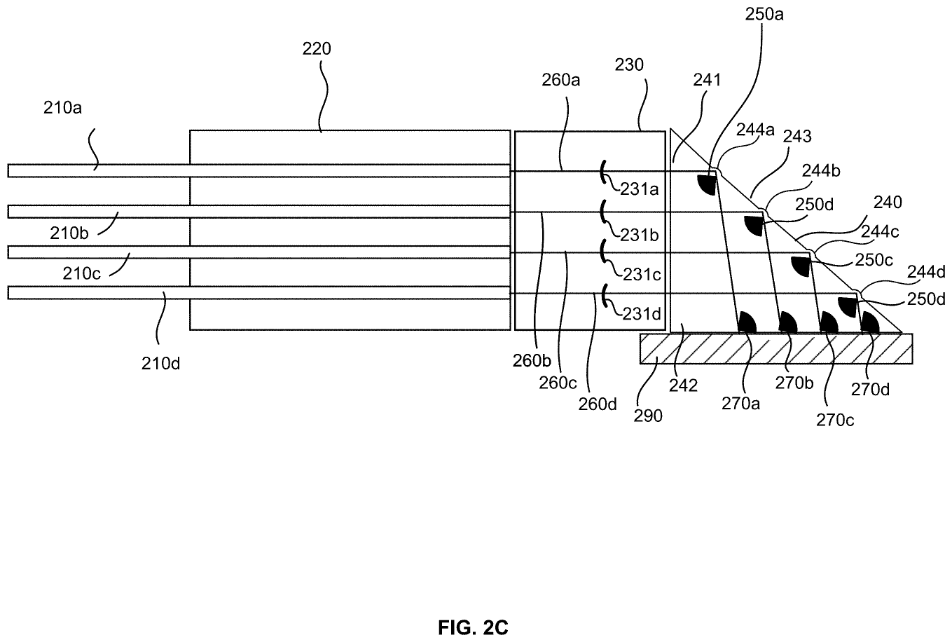

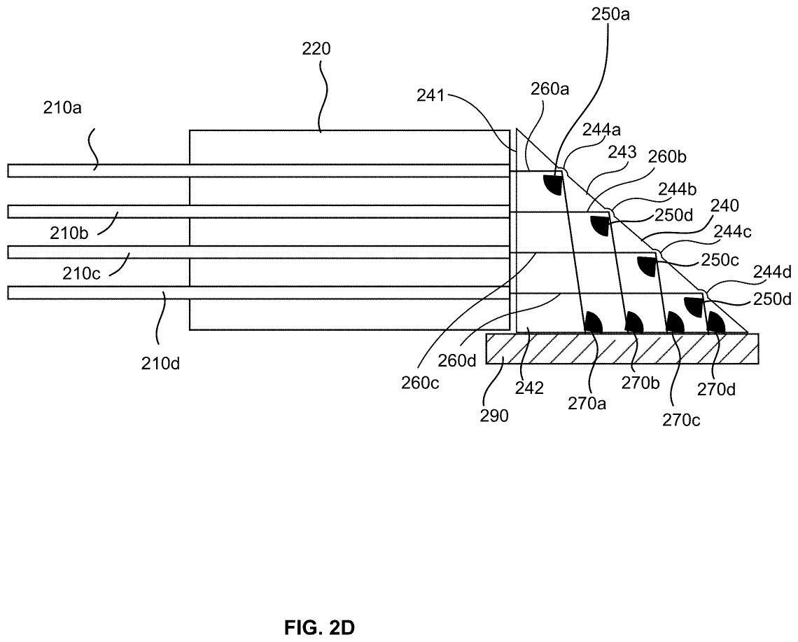

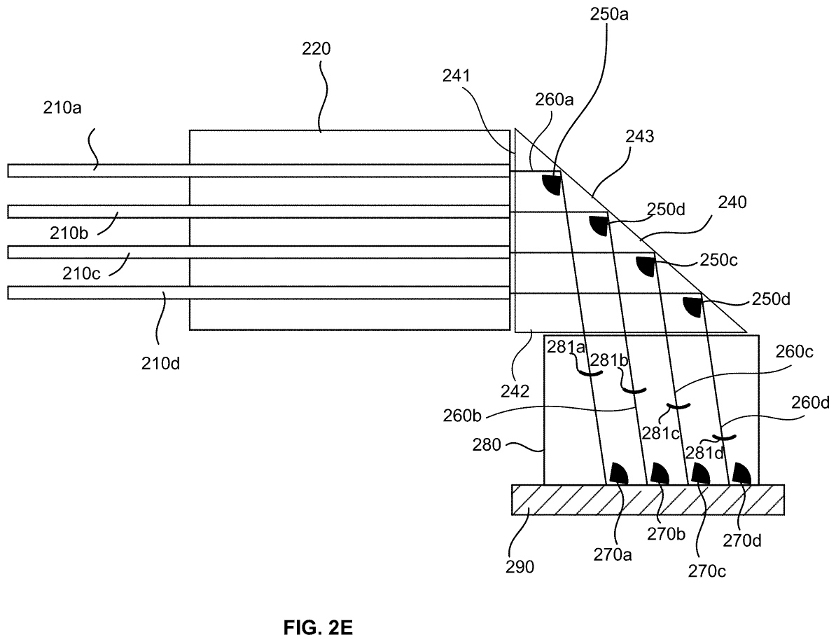

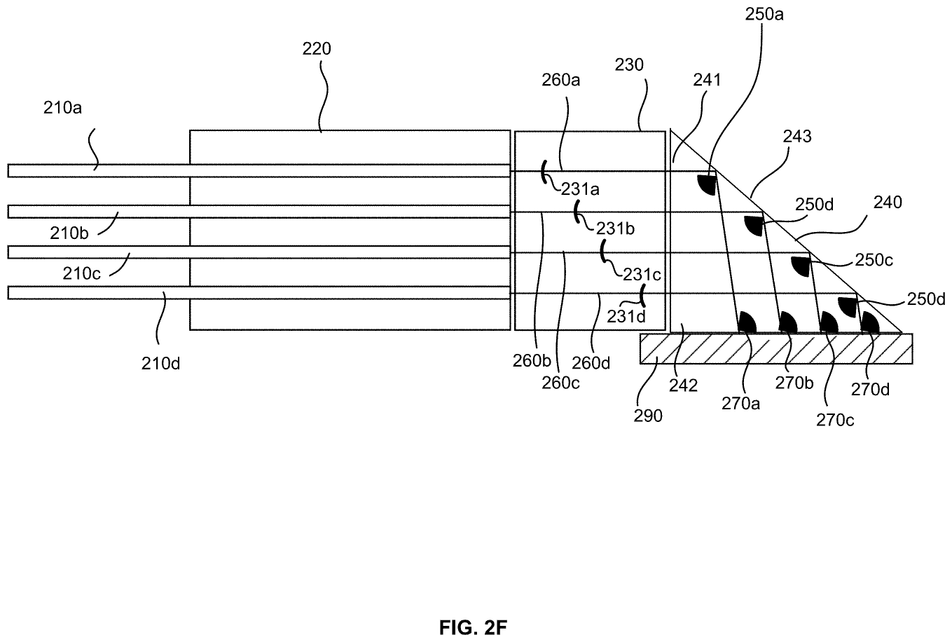

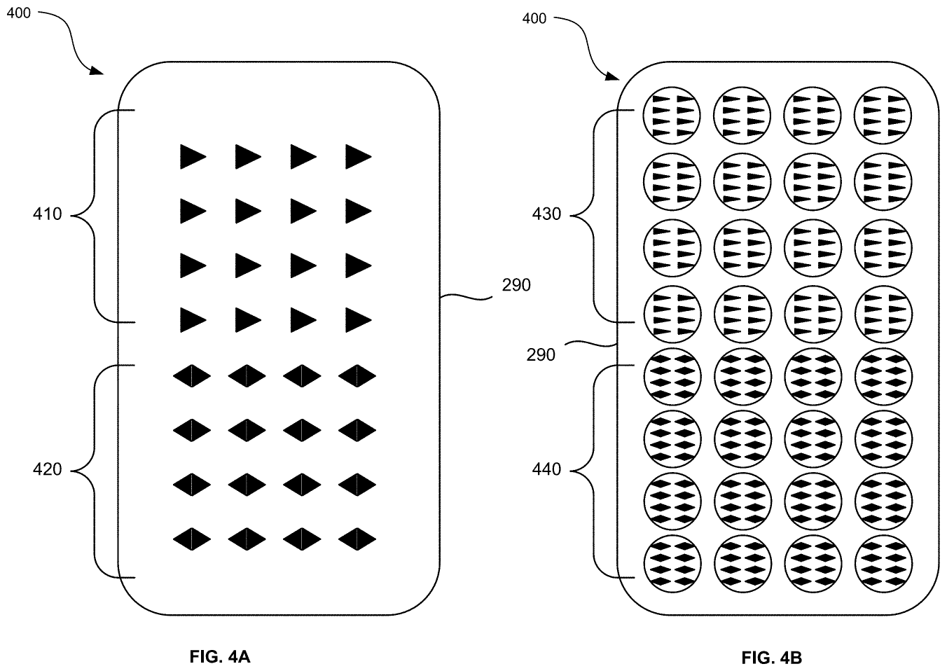

FIGS. 2A-2F illustrate side views of a high density fiber interface for silicon photonics based integrated-optics products with a two-dimensional array of integrated optics, according to example embodiments of the disclosure. The side view of the fiber interface shows the beam paths that couple light into or out of a photonic interposer 290 via an array of grating couplers (discussed in greater detail in regard to FIGS. 4A and 4B) from or to a plurality of optical fibers 210a-d (generally or collectively, optical fibers 210). In various embodiments, each of the elements of the optical device are made of silicon, which provides the optical device with an even coefficient of thermal expansion, and robust manufacturing processes to produce the individual elements. In other embodiments, the various elements of the optical device can be made with materials other than silicon that have matching Coefficients of Thermal Expansion (CTE) to one another (e.g., CTE₁=CTE₂±10%).

Depending on the space requirements for installing the optical device to interface with the interposer 290, a fabricator may use any of the arraignments shown in FIGS. 2A-2F, which may optically couple the optical fibers 210 directly to the prism 240 (as in FIGS. 2B, 2D, and 2E) or use an intermediary fiber lens array 230 (as in FIGS. 2A, 2C, and 2F) and may optically couple the grating couplers of the interposer directly to the prism 240 (as in FIGS. 2C, 2D, and 2F) or use an intermediary interface lens array 280 (as in FIGS. 2A, 2B, and 2E).

Input optical signals are carried by one or more optical fibers 210a-d for transmission to the photonic interposer 290, and output optical signals are carried by one or more of the optical fibers 210 for transmission to external optical devices. In various embodiments, the optical fibers 210 are single-core fibers that are each configured to carry one or more optical signal, while in other embodiments, the optical fibers 210 are multicore fibers made of multiple fiber cores that are configured to carry multiple optical signals on the separate cores with one or more signals on each core. Although shown in FIGS. 2A-2D as a set of four optical fibers 210a-d, in various embodiments more or fewer optical fibers 210 can be included in the set in various arrangements with the optical fibers 210 arranged into one-dimensional arrays (i.e., having one of a height or a width including more than one member) or two-dimensional arrays (i.e., having both a height and a width including more than one member).

A fiber interface 220 collects and provides mechanical support for the various optical fibers 210, which may be connected to different ports of one or more external devices, and arranges the optical fibers 210 into an array with a known layout of the optical fibers 210. In various embodiments, the array includes evenly spaced optical fibers 210 in a grid pattern (e.g., x rows of y columns), in a repeated quincunx pattern (e.g., x rows of y columns interleaved with x−1 rows of y−1 columns similarly to the five-pip face on dice), in a staggered pattern (e.g., x rows of y columns interleaved with x rows of y columns in an uneven quincunx pattern), in various geometric shapes (e.g., a circular pattern), or various even or unevenly spaced arrangements according to various user-defined patterns. In various embodiments, the fiber interface 220 is made of silicon, borosilicate glass, or other material with suitable mechanical properties and thermal expansion matching.

In some embodiments, such as in FIGS. 2A, 2C, and 2F, a collimating or focusing (depending on propagation direction) lens array 230 is provided at the interface of the optical fibers 210 and the next optical element (e.g., e.g., a beam splitter, a polarization splitter, a polarization rotator, or a prism 240) in the beam path to provide collimated or focused optical signals to that optical element. The fiber lens array 230 includes a plurality of fiber lenses 231a-d (generally or collectively, fiber lenses 231) corresponding to the number and pattern of optical fibers 210 in the fiber interface 220. In various embodiments, the fiber lens array 230 and the fiber lenses 231 therein are made of silicon. However, in some embodiments, such as is shown in FIGS. 2B, 2D, and 2E, the fiber lens array 230 may be omitted, instead using one or more lenses defined in the reflective surface 243 of the prism 240 or the interface lenses 281 defined in the interface lens array 280.

A prism 240, which includes one or more reflective surfaces 243 or coatings therein is configured to redirect optical signals between a first surface 241 and a second surface 242 (and vice versa) at a given angle of incidence 250a-d (generally, or collectively angle of incidence 250) for each of the optical signals 260a-d (generally or collectively optical signals 260) received from the respective optical fibers 210a-d for transmission to the interposer 290 or received from the interposer 290 for transmission to an external optical device via associated optical fibers 210a-d. The prism 240 can be made of any material that is optically transparent at the used wavelengths and include various surface treatments to affect the reflectivity and transmissivity of the reflective surfaces 243, the first surface 241, and/or the second surface 242.

The angles of incidence 250 correspond to the angles of coupling 270a-d (generally or collectively, angle of coupling 270) used by the coupling structures in the transmission or reception of optical signals out of or into the interposer 290. Because the angle of coupling 270 is non-normal (i.e., specifically chosen to be greater than or less than 90 degrees or otherwise outside of a tolerance range of a nominally normal or perpendicular angle). In some embodiments, the angles of coupling 270 are set to approximately 8 degrees (±Y degrees).

In some embodiments, such as in FIGS. 2A, 2B, and 2E, an interface lens array 280 is provided between the prism 240 and the interposer 290 to focus or collimate optical beams transmitted to or received from the interposer 290. The interface lens array 280 includes a plurality of interface lenses 281a-d (generally or collectively, interface lenses 281) corresponding to the number and pattern of coupling devices included in the interposer 290. In various embodiments, the interface lens array 280 and the interface lenses 281 therein are made of silicon. However, in some embodiments, such as is shown in FIGS. 2C, 2D, and 2F, the interface lens array 280 may be omitted, instead using one or more prism lenses 244 defined in the reflective surface 243 of the prism 240 or the fiber lenses 231 defined in the fiber lens array 230.

In various embodiment, the reflective surface 243 is curved or includes curved sections to provide one or more prism lens 244a-d (generally or collectively prism lens 244) in the prism 240 to augment or replace the lenses in the fiber lens array 230 or the interface lens array 280. The reflective surface 243, when including prism lenses 244, may be referred to as a lensed reflecting surface. As shown in FIGS. 2B-2D, the prism lenses 244a-d correspond to the pathways for the optical signals 260a-d to reflect and couple the optical signals 260 between the optical fibers 210 and the interposer 290. However, in other embodiments, the reflective surface 243 may be provided as a single prism lens 244 to reflect and focus the optical signals 260. As shown, the prism lenses 244 are concave reflectors.

To ensure that the prism lenses 244 couples the optical signals within specified parameters between the optical fibers 210 and various gratings in the interposer 290, the prism lenses 244 can be located at an optical center or nodal point of the light path for the respective optical signal 260, as in FIG. 2D. In various embodiments, when the prism lenses 244 used in conjunction with one of the fiber lenses 231 (as in FIG. 2C) or the interface lenses 281 (as in FIG. 2B), the optical center or nodal point for the respective optical signals 260 may be located between a pair of a prism lens 244 and fiber lens 231 or interface lens 281. Additionally or alternatively, when using one of fiber lenses 231 or interface lenses 281 and omitting prism lenses 244 (as in FIGS. 2E and 2F), the respective fiber lenses 231 or interface lenses 281 may be located at an optical center or nodal point of the light path for the respective optical signals 260.

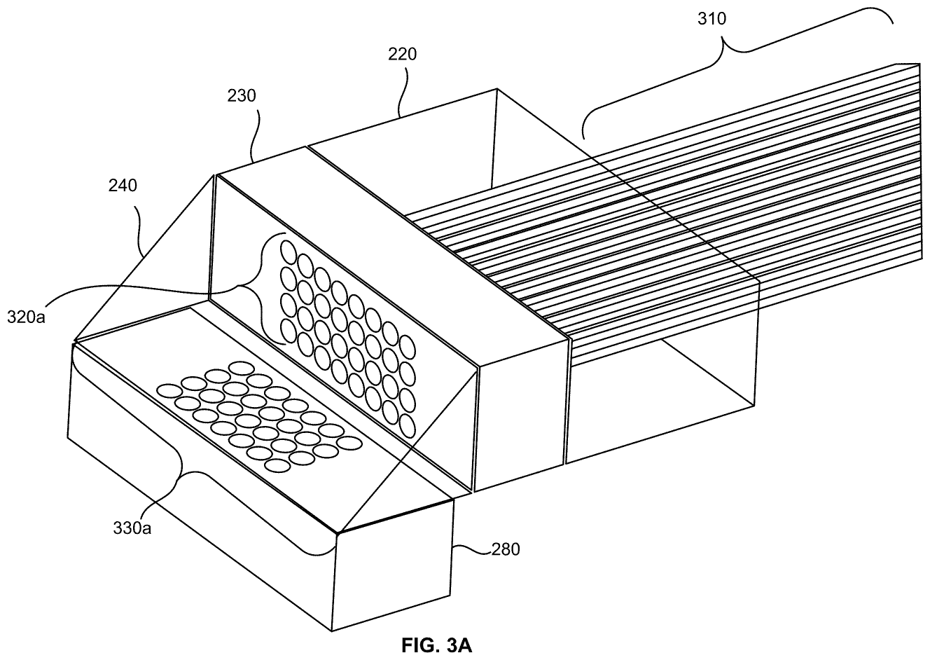

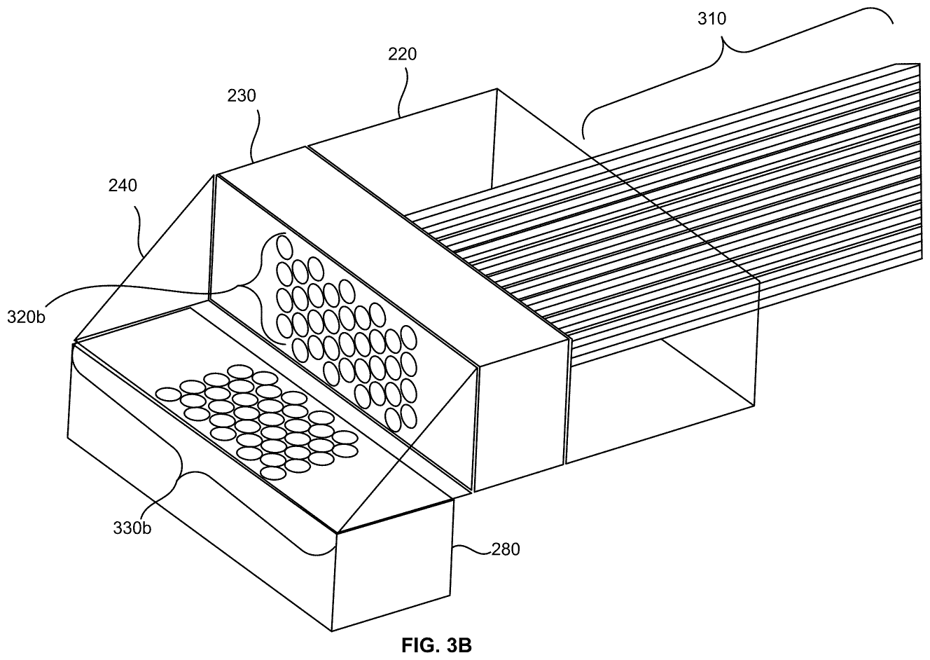

FIGS. 3A and 3B illustrate isometric views of the high density fiber interface, according to example embodiments of the disclosure. An array of optical fibers 310 (e.g., the collective optical fibers 210 shown individually in FIGS. 2A-2F) is secured by a fiber interface 220 in a known arrangement in a two-dimensional array. As shown in FIG. 3A, the two-dimensional array is provided in a first pattern 320a with the optical fibers 310 arranged in gird of rows and columns. As shown in FIG. 3B, the two-dimensional array is provided in a second pattern 320b with the optical fibers 310 arranged in quincunx pattern of rows and columns with an offset between even and odd rows or columns. Corresponding patterns 330a-b are shown in FIGS. 3A and 3B, respectively, to interface the optical signals into or out of the interposer (290). These patterns 320a-b are propagated to the fiber lens array 230 (if included) and the corresponding patterns 330a-b are propagated to the interface lens array 280 (if included). Although two arrangements are shown in FIGS. 3A and 3B, various other patterns for various numbers of optical fibers 310 are contemplated by the present disclosure.

FIGS. 4A and 4B illustrate surface views of an interface region 400 of a silicon photonic that the high density fiber interface optically couples with, according to example embodiments of the disclosure. Each optical signal carried by an individual optical fiber 210 enters or exits the silicon photonic chip via a corresponding coupling structure defined in the interposer 290 couples to a corresponding waveguide within the silicon photonic chip.

FIG. 4A illustrates an example layout of the interface region 400 when the optical fibers 210 are single-core fibers. An input set 410 of coupling structures (such as grating couplers) are arranged to receive signals carried by corresponding fibers 210 and transfer the optical signals to corresponding waveguides within the silicon photonic. Similarly, an output set 420 of coupling structures are arranged to transfer optical signals from a corresponding waveguide in the silicon photonic chip to a corresponding fiber. Although shown with a given number coupling structures in each of the input set 410 and the output set 420, in various embodiments different arrangements and different numbers of coupling structures can be included in each of the sets.

FIG. 4B illustrates an example layout of the interface region 400 when the optical fibers 210 are multi-core fibers. An arrayed input set 430 of arrayed coupling structures (such as grating couplers) are arranged to receive signals carried by each core of the corresponding fibers 210 and transfer the optical signals to corresponding waveguides within the silicon photonic. Similarly, an arrayed output set 440 of arrayed coupling structures are arranged to transfer optical signals from a corresponding waveguide in the silicon photonic to a corresponding core in an optical fiber 210. Although shown with eight coupling structures in each array, in various embodiments, the number and arrangement of the coupling structures can be different in different embodiments that use more or fewer cores in each multi-core fiber or different arrangements of cores therein. Similarly, although shown with a given number coupling structures in each of the input set 430 and the output set 440, in various embodiments different arrangements and different numbers of coupling structures can be included in each of the arrayed sets.

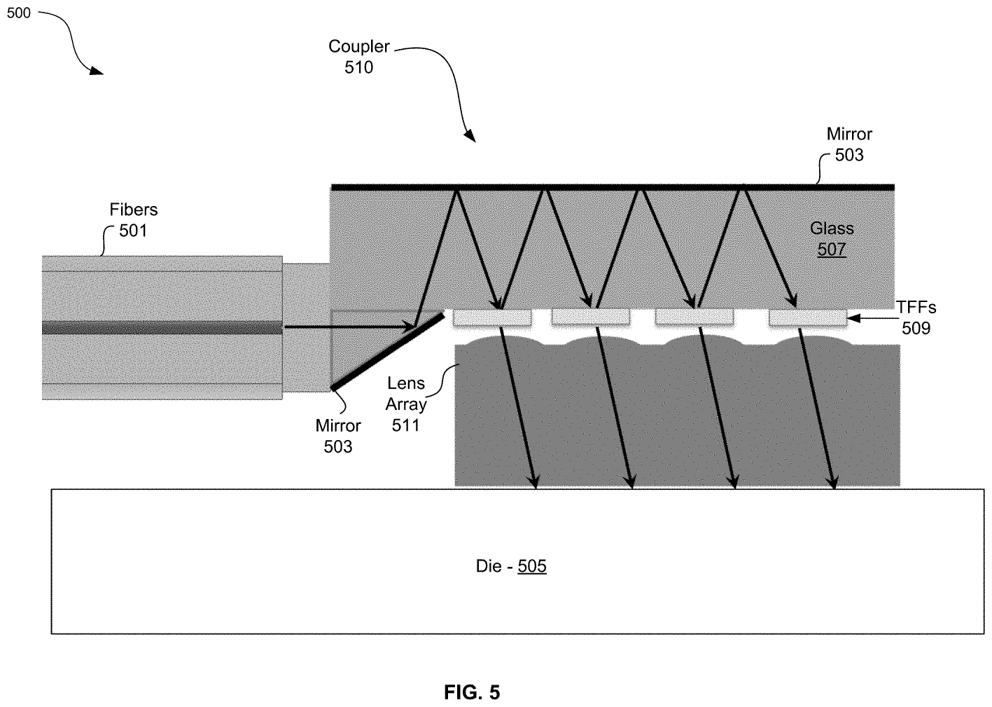

FIG. 5 is a schematic illustrating thin film filters with a launching filter, in accordance with an embodiment of the disclosure. Referring to FIG. 5, there is shown a transceiver 500 with optical signals coupled via fibers 501 and a coupler 510. The coupler 510 comprises mirrors 503, glass 507, thin film filters (TFFs) 509, and a lens array 511. The coupler 510 may be configured to direct optical signals into photonic interposer die 505 at near-normal incidence.

The fibers 501 may comprise one or more optical fibers for coupling optical signals to and from the coupler 510 and photonics die 505. The fibers may comprise single mode or multi-mode fiber. In an example scenario, one fiber is used to couple signals into the coupler 510 and subsequently to the photonics die 505, while a second fiber receives optical signals from the photonics die 505 via the coupler 510.

The glass 507 may comprise a machined and/or polished highly transparent structure on which optical components such as mirrors and filters may be formed. For example, one or more layers of a highly reflective metal, such as gold, for example, may be deposited on highly polished surfaces of the glass 507, thereby forming mirror 503. Similarly, filter structures may be formed by depositing stacks of dielectric layers on the glass 507, thereby forming the TFFs 509, for example. Accordingly, the glass 507 may guide optical signals from the fiber 501 end to the TFF 509 end, and vice versa.

The lens array 511 may comprise a micro-machined silicon structure, for example, with lens structures formed therein that are operable to focus optical signals received from the TFFs 509 to specific spots on the photonics die 505, such as grating couplers. While convex lensing structures are shown, other shapes may be utilized depending on desired focal length, the dielectric constant of the lens material used, and space requirements, for example.

The TFFs 509 may comprise stacks of alternating dielectric constant materials resulting in structures that are reflective at most wavelengths but allow light of specific wavelengths to pass through. Each of the TFFs 509 may be tuned to different wavelengths, which may be useful for CWDM applications. While four TFFs 509 are shown in FIG. 5, any number of TFFs may be used depending on the number of desired different wavelengths.

The mirrors 503 may comprise a highly reflective material, such as a metal, formed on the glass 507, for directing the optical signals to the TFFs 509 from the fibers 501. The fibers 501 may comprise collimators at their outputs for providing collimated beams to the coupler 510.

In operation, optical signals may be coupled into the coupler 510 via the fibers 501 and reflected by the mirrors 503 and TFFs 509, resulting in a multi-reflection configuration. The TFFs 509 are each configured to reflect all signals except for those in a specific wavelength range. In this manner, specific wavelength optical signals may be coupled to specific locations on the photonics die 505, preferably to grating couplers tuned to the specific wavelength. The mirrors 503 enable a substantially vertical impingement on the TFFs 509, so that further reflecting structures are not needed after the TFFs 509 for desired near-normal incidence on the photonics die 505, thereby maximizing the coupling efficiency of optical signals in to the photonics die 505.

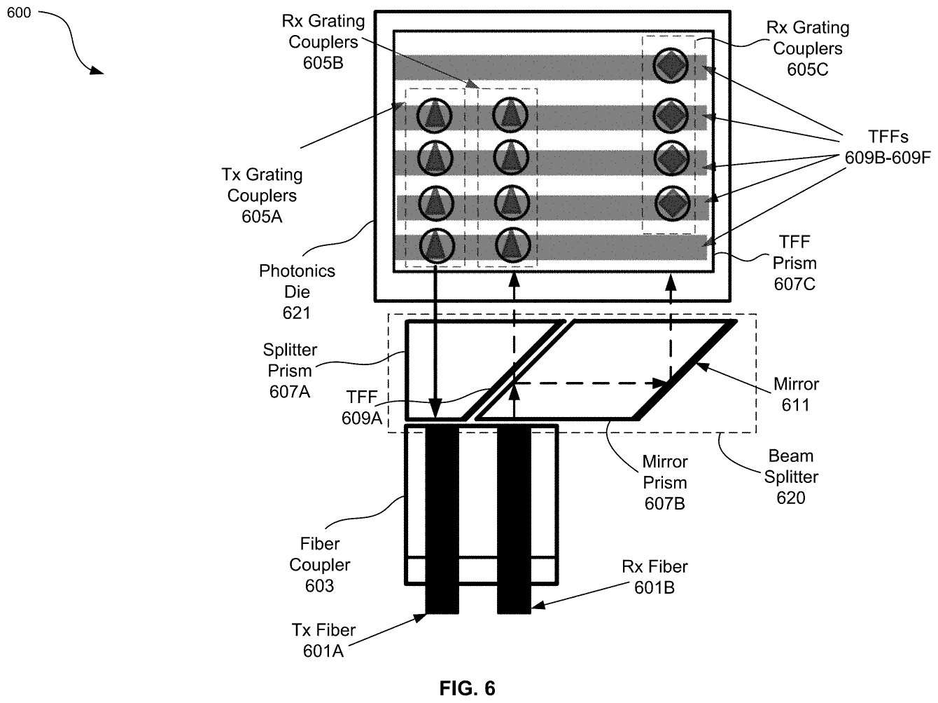

FIG. 6 illustrates an optical transceiver with a spatial separation beam splitter, in accordance with an example embodiment of the disclosure. Referring to FIG. 6, there is shown a transceiver 600 comprising Tx fiber 601A, Rx fiber 601B, a fiber coupler 603, a photonic die 621, and beam splitter 620. The photonic die 621 may be similar to the photonic die described earlier with respect to FIGS. 1-4, and may comprise the Tx grating couplers 605A and Rx grating couplers 605B and 605C. In an example scenario, the Tx couplers 605A and Rx grating couplers 605B may comprise single polarization grating couplers and the Rx grating couplers 605C may comprise polarization splitting grating couplers.

The prism 607C may comprise a transparent structure with thin film filters formed on sloped surfaces for reflecting desired signals down to the Rx grating couplers 605B and 605C as well as from the Tx grating couplers 605A to the Tx fiber 601A via the splitter prism 607A. The prism 607A may also have thin films formed on an angled surface thereby forming TFF 609A for splitting signals of different polarizations upon hitting the sloped surface, while mirror prism 607B comprises layers formed on an angled surface to provide a mirror 611 for reflecting signals from the TFF 609A to the Rx grating couplers 605C.

The transceiver 600 incorporates the beam splitter 620 comprising the TFF 609A in the splitter prism 607A and the mirror 611 in the mirror prism 607B to spatially separate signals of different polarizations, such that the different Rx grating couplers 605B and 605C may be utilized for different polarizations and wavelengths from a single received CWDM signal. In addition, the transceiver comprises a 5^{th} TFF for the 4^{th} p-polarization.

Each TFF 609B-609F may be designed to reflect the s-polarization of one CWDM band and p-polarization of the previous CWDM band while allowing others to pass through. This approach has the band-edges of the p- and s-polarization transmissions deliberately separated. In this example, the delta between them is set to 20 nanometers (nm) (e.g., CWDM channel spacing). The delay between the two polarizations can be readily compensated on silicon, such as with a few hundred microns of extra waveguide length on one side, for example.

In operation, the transceiver 600 is operable to receive and transmit CWDM4 signals through the use of spatially separated polarization splitters and wavelength sensitive thin film filters. Four optical signals at different CWDM wavelengths may be generated in the photonics die 621, such as described previously, and coupled out of the die via the Tx grating couplers 605A. The TFFs 609B-609F reflect each of the signals out of the TFF prism 607C into the splitter prism 607A and into the Tx fiber 601A, thereby generating a CWDM4 signal transmitted into the fiber 601A.

Similarly, a CWDM signal may be received via the Rx fiber 601B and coupled to the beam splitter 620 where one polarization passes through the TFF 609A to the TFF prism 607C, where each of the TFFs 609B-609F reflects a particular wavelength and polarization signal down to the Rx grating couplers 605B, which couple the corresponding wavelength signal into the photonic die 621 for processing. The other polarization signals at the TFF 609A are reflected laterally to the mirror 611, which reflects the signals into the TFF prism 607C, where the TFFs 609B-609F each reflect a specific wavelength and polarization signal down to the Rx grating couplers 605C, which couple the signals into the photonic die 621 for processing.

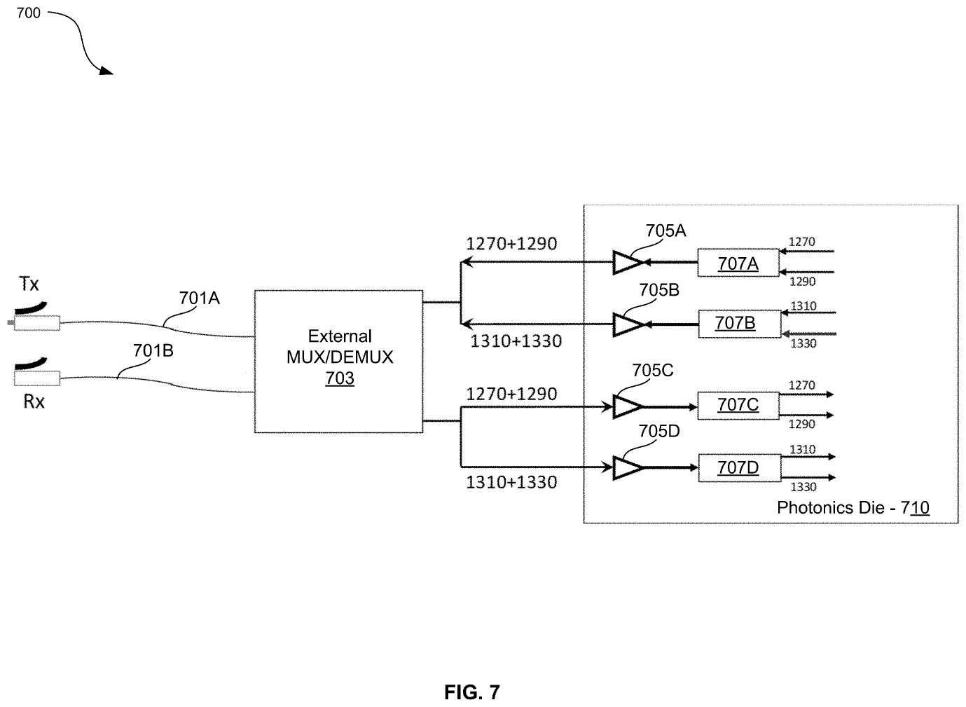

FIG. 7 illustrates an architecture with distributed MUX/DEMUX function, in accordance with an example embodiment of the disclosure. Referring to FIG. 7, there is shown a transceiver 700 with optical fibers 701A and 701B, external MUX/DEMUX 703 and photonics die 710. The photonics die 710 may comprise an interposer with optical and optoelectronic devices, such as grating couplers 705A-705D and multiplexers/demultiplexers 707A-707D, with each coupler and MUX/DEMUX operable to communicate split an input signal into two different wavelengths and/or combine two signals into one, although the disclosure is not limited to this example.

By integrating a portion of the MUX/DEMUX function in the die 710 and a portion external to the interposer die 710, this may leverage the strengths of each platform enabling a manufacturable high density solution. The external MUX/DEMUX 703 may comprise an array of thin film filters or birefringent material, for example, for separating the input optical signal into two separate signals of two wavelengths each. The on-chip multiplexers/demultiplexers 707A-707D may comprise optical waveguides with phase modulation sections, optical couplers, and photodetectors, as described in U.S. patent application Ser. No. 15/805,803, which is hereby incorporated herein by reference in its entirety.

In the example shown in FIG. 7, four CWDM wavelengths may be transmitted and received. For example, the Rx optical fiber 701B may receive an input optical signal comprising four optical signals of different wavelengths, e.g., 1270 nm, 1290 nm, 1310 nm, and 1330 nm, in this example. The external MUX/DEMUX 703 may split the received input signal and output two signals comprising two wavelengths, 1270/1290 nm and 1310/1330 nm for example. These optical signals may then be coupled into the photonics die 710 via the grating couplers 705C and 705D. Each of these signals may then be further demultiplexed by on-chip demultiplexers 707C and 707D, resulting in four separate signals of different wavelengths.

In addition, the transceiver 700 may couple a wavelength division multiplexed signal into the Tx optical fiber 701A. Four signals of four wavelengths, such as 1270 nm, 1290 nm, 1310 nm, and 1330 nm may be coupled into the MUX/DEMUX 707A and 707D, where MUX 707A multiplexes the 1270 nm and 1290 nm signals into a single optical signal and the MUX 707B multiplexes the 1310 nm and 1330 nm signals into a single signal. These two multiplexed signals may then be communicated out of the photonics die 710 via the grating couplers 705A and 705B to the external MUX/DEMUX 703. The two received signals may then be further multiplexed by the external MUX/DEMUX 703 unto a single output signal on the Tx optical fiber 701A.

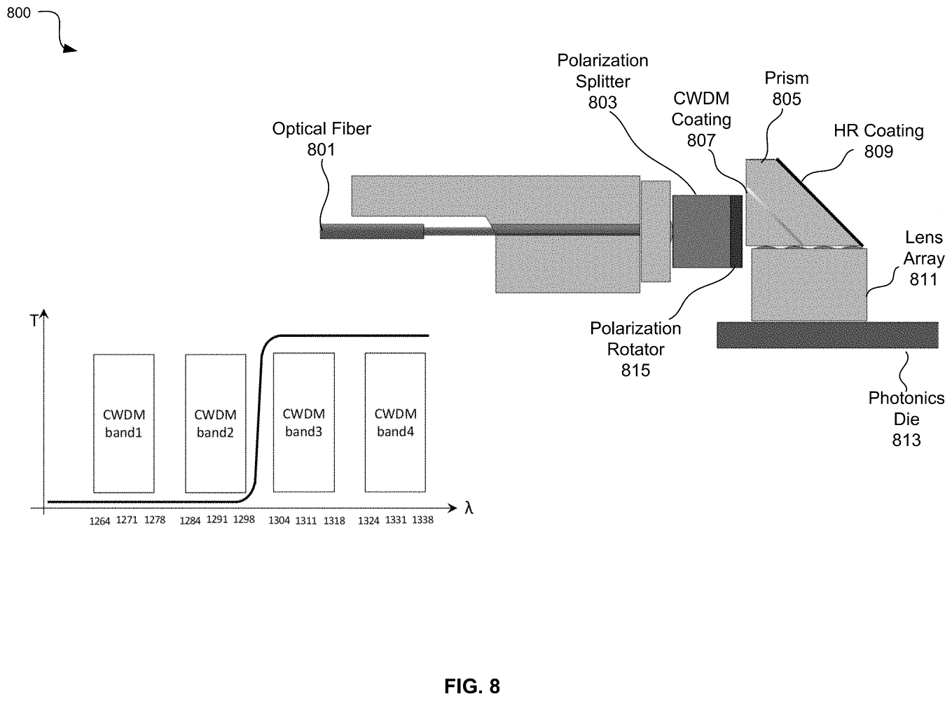

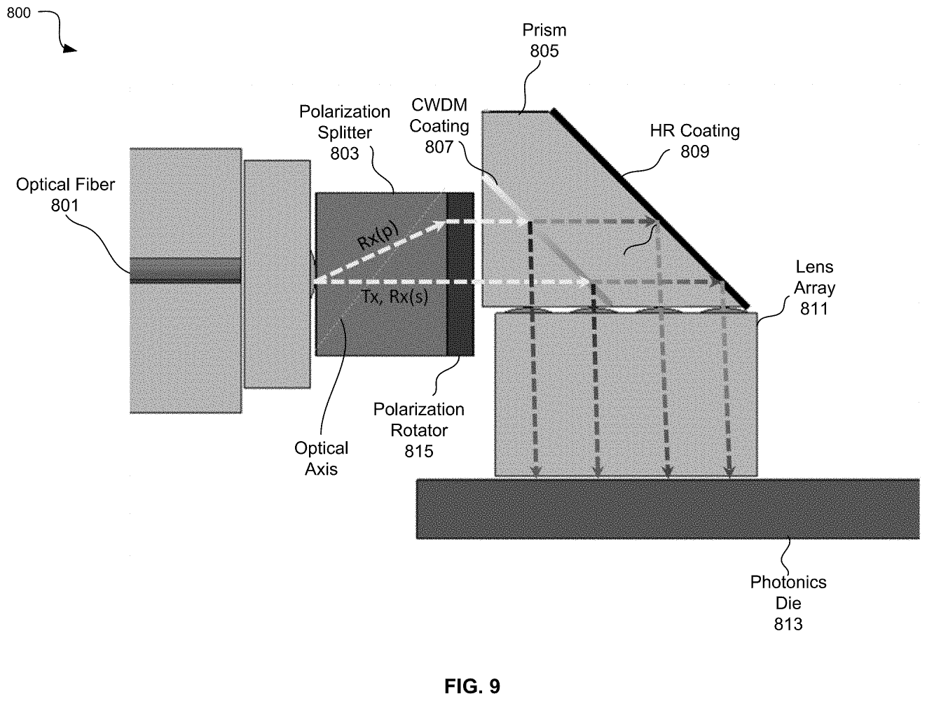

FIG. 8 illustrates details of an external multiplexer/demultiplexer, in accordance with an example embodiment of the disclosure. Referring to FIG. 8, there is shown an external MUX/DEMUX 800 coupled to a photonics die 813, with an input/output fiber 801, polarization splitter 803, prism 805, lens array 811, and polarization rotator 815. The polarization splitter 803 may comprise a birefringent material or spatially separating and polarization-dependent thin film filters, for example, that may separate optical signals of different polarization spatially so that each signal may be reflected downward to corresponding grating couplers in the photonics die 813 via the CWDM coating 807 or the HR coating 809. In an example scenario, the polarization splitter 803 comprises a spatially homogenous structure, such as when it comprises a birefringent material. The polarization splitter acts as a combiner when signals of different polarization impinge on the output side, communicating the combined signal out of the input side shown in FIG. 9. The polarization rotator 815 may comprise a half-wave plate rotator for a 45 degree polarization rotation, for example. In another example embodiment, the outputs of the polarization splitter may be rotated by different amounts in order to equalize their polarizations after the rotator.

The CWDM coating may comprise a stack of thin films on an angled plane in or on the prism 805 that are configured to reflect signal of a desired wavelength and allow others to pass. An example high pass spectrum is shown in FIG. 8 in the lower left plot, where CWDM bands 3 and 4 are transmitted through the CWDM coating 807 while the CWDM bands 1 and 2 are reflected downward to the photonics die 813 via the lens array 811, which may focus the signals onto corresponding grating couplers.

Signals that pass through the CWDM coating 807 may then be reflected by the HR coating 809, which comprises a high reflectivity coating, such as a metal for example, formed on an angled plane of the prism 805. The reflected signals may be focused by the lens array 811 onto corresponding grating couplers in the photonics die 813.

FIG. 9 illustrates a side view of an external multiplexer/demultiplexer, in accordance with an example embodiment of the disclosure. Referring to FIG. 9, there is shown a side view of MUX/DEMUX 800 with optical fiber 801, polarization splitter 803, lens array 811, photonics die 813, polarization rotator 815, and prism 805 comprising CWDM coating 807 and HR coating 809, as described above with respect to FIG. 8. In addition, the optical axis of the polarization splitter 803 is indicated by the dashed line.

In this example, receive polarization diversity is handled with the external MUX/DEMUX 800 eliminating polarization dependent loss of CWDM filters and allows single polarization grating couplers in the photonics die 813 as opposed to polarization splitting grating couplers. The optical beam paths may be configured to maintain highest density, and the short throw distance of this structure allows the use of a birefringent rotator for the polarization splitter 803. In addition, the polarization rotator 815 may comprise a half wave plate 45 degree polarization rotator. In another example embodiment, the polarization rotator 815 may rotate the outputs of the polarization splitter by different amounts in order to equalize their polarizations after the polarization rotator 815.

The beam paths for the different wavelengths and polarizations are shown by the dashed lines, where the longer wavelength signals pass through the CWDM coating 807 and are reflected down to the lens array 811 by the HR coating 809. In addition, the birefringent material, in this example, in the polarization splitter 803 deflects the p-polarization signals upward to impinge on the CWDM coating 807 at a higher location than the s-polarization signals that pass straight through. This same process works in reverse for signals coming from the photonics die 813. In this manner, with polarization control and spatial separation, single polarization grating couplers may be used in the photonics die 813 independent of the polarization.

In an example scenario, a ˜45 degree angle-of-incidence (AOI) design significantly lowers throw distances, which can be leveraged to increase areal channel density. For instance, a fiber spacing of 127 □m between Tx and Rx can be readily achieved. The simple high-pass spectral response minimizes issues with angle sensitivity of a 45 degree AOI filter. A single reflection from a filter also greatly lowers impact of filter warpage, compared to cumulative angle error seen after multiple bounces in a conventional Z-block design. This allows for easier scaling to accommodate much larger fiber counts in the same filter piece. Furthermore, optical beams also go through the filter once, which minimizes accrual of insertion loss that would be seen for last dropped channel in a 4-channel CWDM4 DEMUX. Finally, the HR coating 809 can be implemented on the back-side of the WDM filter to get good control over spacing of the two sets of reflected beams.

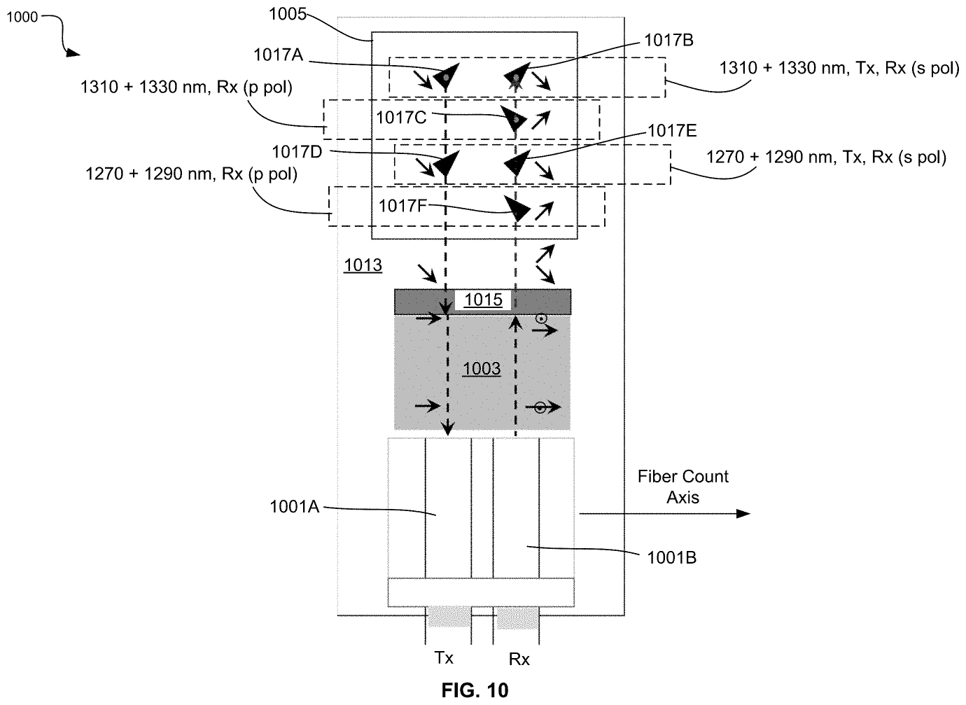

FIG. 10 illustrates a top view and beam paths of an external multiplexer/demultiplexer, in accordance with an example embodiment of the disclosure. Referring to FIG. 10, there is shown a top view of MUX/DEMUX 1000 with optical fibers 1001A and 1001B, polarization splitter 1003, silicon interposer 1013, and polarization rotator 1015, grating couplers 1017A-1017F, and prism 1005 comprising CWDM coating 807 and HR coating 809, as described above with respect to FIG. 8.

The MUX/DEMUX 1000 demonstrates “spatially homogenous” polarization splitting in that there is no fine alignment feature in the separator/rotator 1003/1015, so scaling along the fiber count axis is simplified, with a simple extrusion of material along the axis. In addition, the polarization separation does not create a vacant position in the fiber array.

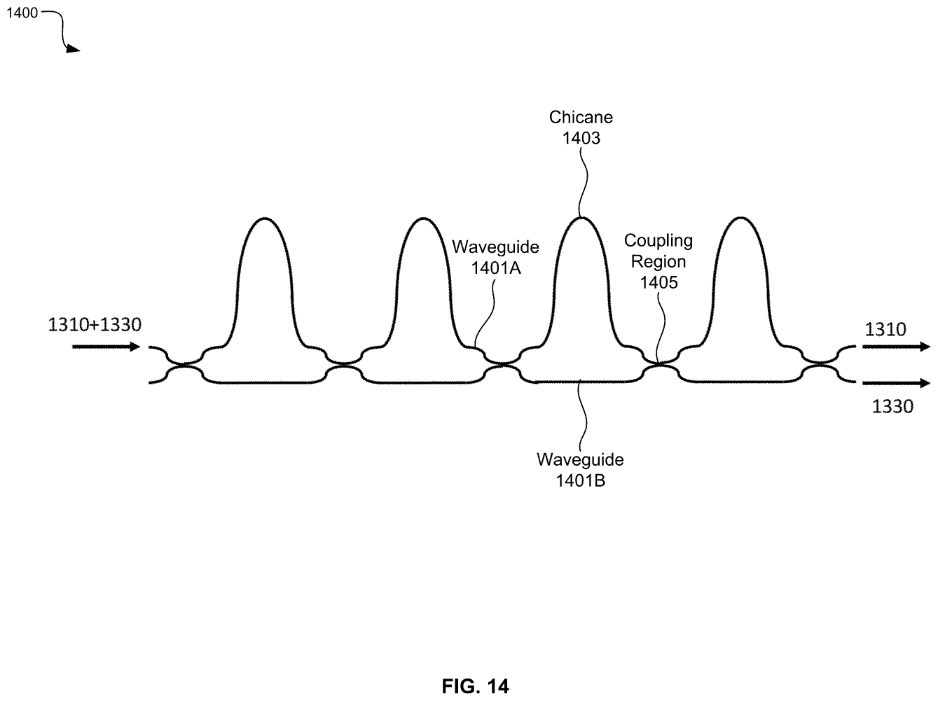

As can be seen in FIG. 10, different wavelength and different polarization signals are communicated via different grating couplers 1017A-1017F. In the example shown, coupler 1017A communicates 1310 nm and 1330 nm Tx optical signals into fiber 1001A via the prism 1005, rotator 1015, and polarization splitter 1003 while coupler 1017D couples 1270 nm and 1290 nm Tx optical signals into fiber 1001A via the prism 1005, rotator 1015, and polarization splitter 1003. The 1310/1330 nm and 1270/1290 nm optical signals may be multiplexed by on-chip multiplexers in the silicon interposer 1013, such as the multiplexer/demultiplexer 1400 described in FIG. 14. In this manner, single polarization grating couplers may be used in the transceiver, which results in lower loss. However, polarization-combining grating couplers may also be used in place of the single polarization grating couplers shown.

Furthermore, the grating couplers 1017B, 1017E, and 1017F may receive optical signals from the prism 1005 and couple them to on-chip demultiplexers, such as the multiplexer/demultiplexer 1400 described in FIG. 14.

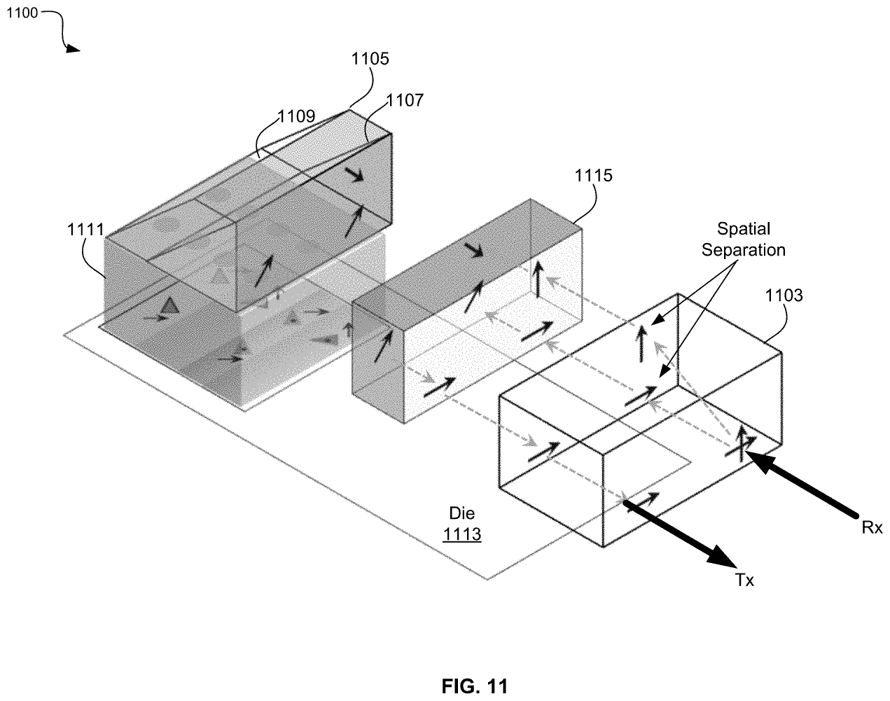

FIG. 11 illustrates an isometric view of the external multiplexer/demultiplexer, in accordance with an example embodiment of the disclosure. Referring to FIG. 11, there is shown an oblique angle view of MUX/DEMUX 1100 with polarization splitter 1103, lens array 1111, photonics die 1113, polarization rotator 1115, and prism 1105 comprising CWDM coating 1107 and HR coating 1109, similar to those described above with respect to FIG. 8. FIG. 11 also shows the polarization of optical signals at various points in the MUX/DEMUX 1100, as indicated by the short arrows.

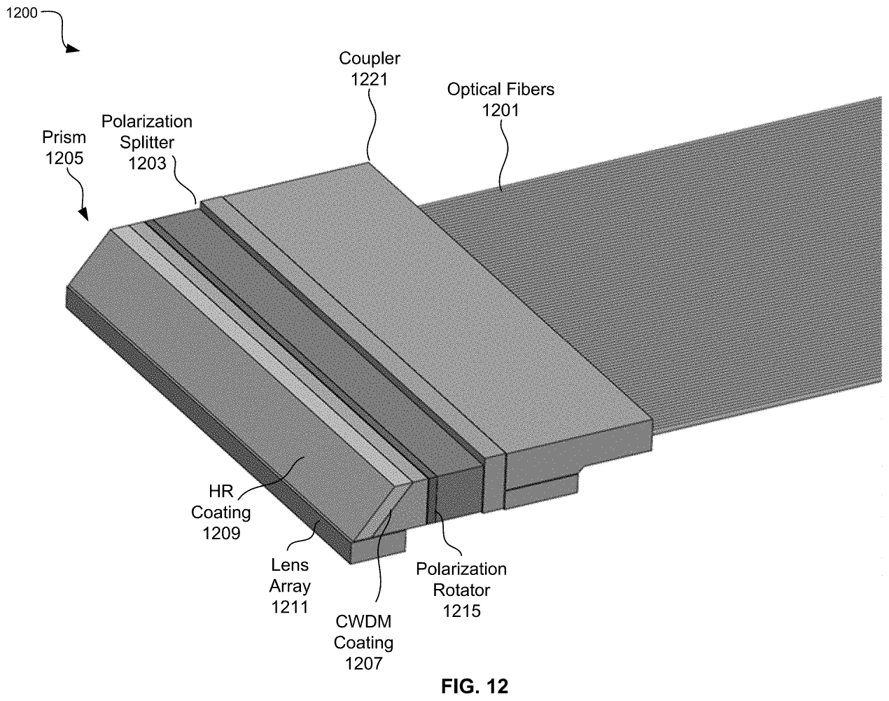

The birefringent crystal in the polarization splitter 1103 creates vertical separation between Rx (from the fiber) s- and p-polarizations as shown in the Rx path at the back surface of the polarization splitter 1103 and at the front surface of the half-wave plate of the polarization rotator 1115. FIG. 11 also illustrates the laterally separated Tx and Rx paths. This illustrates the expandability of the structure, in that more fibers can be incorporated laterally, thereby adding more channels, as shown in FIG. 12.

FIG. 12 illustrates the scaling capability of an external multiplexer/demultiplexer, in accordance with an example embodiment of the disclosure. Referring to FIG. 12, there is shown an oblique angle view of a MUX/DEMUX 1200 with optical fibers 1201, polarization splitter 1203, lens array 1211, polarization rotator 1215, and prism 1205 comprising CWDM coating 1207 and HR coating 1209, each similar to similarly named elements as described above with respect to FIG. 8. There is also shown a coupler 1221 for providing physical/mechanical support for the array of optical fibers 1201.

The distributed MUX/DEMUX design described here enables scaling to high channel counts since the external MUX/DEMUX functionality can be readily extruded along fiber-count axis as shown. In an example embodiment, a 64 fiber solution supporting 32 4×100G transceivers is shown in FIG. 12.

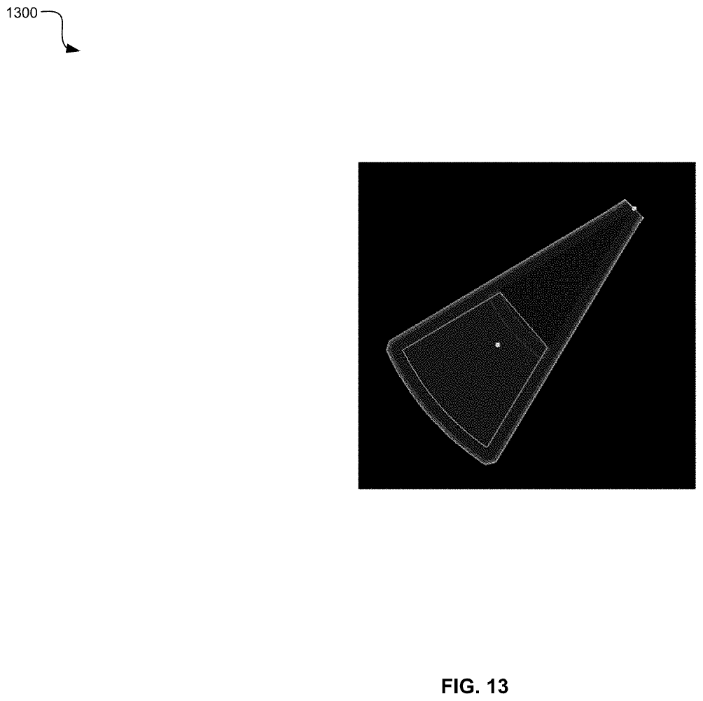

FIG. 13 illustrates a broadband angled fiber grating coupler, in accordance with an example embodiment of the disclosure. Referring to FIG. 13, there is shown a broadband grating coupler 1300 with 40 nm 1 dB bandwidth that is a single-polarization grating coupler, which may be employed on both Tx and Rx sides of the transceivers shown in FIGS. 1-9. The grating coupler 1300 comprises an array of curved gratings in a photonics die where the change of index from silicon to silicon dioxide, nitride, or air, for example, provide scattering of optical signals such that light impinging from a vertical direction is scattered into the plane of the photonics chip. The external polarization splitting described above allows for the elimination of more complex polarization splitting grating couplers on the Rx side, which makes design of broadband grating couplers more tenable. The single polarization is +/−45 deg, which enables scalability of a high density external MUX/DEMUX design.

FIG. 14 illustrates an on-chip two-channel multiplexer/demultiplexer, in accordance with an example embodiment of the disclosure. Referring to FIG. 14 there is shown MUX/DEMUX 1400 with a pair of waveguides 1401A and 1401B with intermittent coupling regions 1405 where they become close enough for optical coupling. In addition one of the waveguides has “chicanes” 1403 or extended lengths for providing a phase shift for optical signals in that path. Further phase modulation may be enabled by PN junctions placed along the waveguides where a bias on the PN junctions cause an index of refraction change and thus a phase change for optical signals passing through.

In the example shown in FIG. 14, MZI lattice filters are employed for the MUX/DEMUX functionality, where 4th order filters are shown. These structures may also be used as clean-up filters with correct free spectral range (FSR) selection. In demonstrated MUX/DEMUX structures fabricated in silicon, the correct phase were set at a calibration step using low-speed phase-modulators (LSPM) and a look-up table for LSPM settings can also be implemented.

In this embodiment a multiplexed optical signal of different wavelengths, 1310 and 1330 nm in this example, is coupled into one input of the MUX/DEMUX 1400 and the 1310 nm signal is output from output waveguide 1101A while the 1330 nm signal is output from the other output waveguide 1401B. The MUX/DEMUX 1400 operates as either a multiplexer or multiplexer, where FIG. 14 shows it operating as a demultiplexer, but operates as a multiplexer by coupling 1310 nm and 1330 nm input signals at both waveguides 1401A and 1401B at one end and outputting the multiplexed 1310/1330 optical signal out of one waveguide 1401A or 1401B at the opposite end.

In an example embodiment of the disclosure, a method and system are described for CWDM MUX/DEMUX designs for silicon photonic interposers. The method and system may comprise an optical transceiver comprising a silicon photonic interposer, a polarization splitter, a lens array, and a prism with a coarse wavelength division multiplexing (CWDM) coating and a high reflectivity (HR) coating, with the polarization splitter, lens array, and prism being coupled to the silicon photonic interposer. An input optical signal comprising a plurality of different wavelength and a plurality of different polarization optical signals may be received. Signals of different polarization may be spatially separated using the polarization splitter and signals of a first wavelength range may be reflected into the lens array using the CWDM coating while signals in a second wavelength range may be passed through the CWDM coating.

Signals of the second wavelength range may be reflected to the lens array using the HR coating, and optical signals may be coupled into the silicon photonic interposer using the lens array. Signals of two different wavelengths in the first wavelength range and signals of two different wavelengths in the second wavelength range may be demultiplexed using demultiplexers in the silicon photonic interposer.

A polarization of signals may be rotated using a polarization rotator between the polarization splitter and the prism. The polarization of the signals may be rotated 45 degrees using the polarization rotator. Outputs of the polarization splitter may be rotated by different amounts in order to equalize their polarizations after the polarization rotator. Signals of four different wavelengths may be multiplexed into two output signals using two multiplexers in the silicon photonic interposer. The two output optical signals may be communicated out of the silicon photonic interposer into the prism via the lens array. The two output optical signals may be multiplexed into a single output signal using the HR coating, the CWDM coating, and the polarization splitter. The input optical signal may be received from one or more optical fibers. The polarization splitter may comprise a birefringent material or spatially separating and polarization-dependent thin film filters. The silicon photonic interposer may comprise a complementary metal oxide semiconductor (CMOS) die.

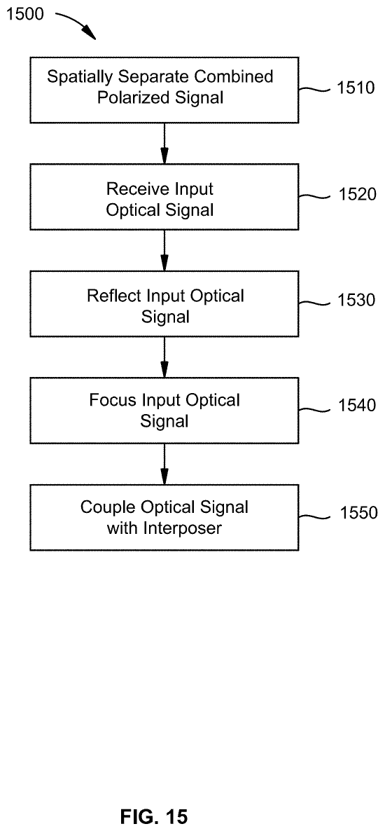

FIG. 15 is a flowchart of a method 1500 of optical signaling in the high density fiber interface and silicon photonic, according to an example embodiment of the disclosure.

Although generally discussed in relation to an optical system receiving an optical signal for transmission to a silicon photonic chip, method 1500 can be understood in the reverse pathway as well, where optical signals are transmitted out of the silicon photonic chip with the various operations being performed in reverse for inbound and outbound optical signals. In various embodiments, method 1500 can be performed in parallel for each inbound optical signal of a plurality of optical signals transmitted to the silicon photonic, and the reverse of method 1500 can be performed in parallel for each outbound optical signal of a plurality of optical signals transmitted from the silicon photonic.

In various embodiments, when performed with an input optical signal coupled into the interposer, the input optical signal is split into two or more sub-signals based on one or more of the polarization and wavelength of those sub-signals, fully or partially demultiplexing the input optical signal into several sub-signals. Accordingly, when performed with an output optical transmitted out of the interposer, the various sub-signals can be fully or partially multiplexed into a single output optical signal through the structure of the optical device.

At operation 1510, when the optical system includes a polarization splitter, inbound optical signals carried on an optical fiber are split from a combined polarized optical signal into separate input optical signals for each polarization (e.g., a first input optical signal or a first polarization and a second input optical signal of a second polarization). The polarization splitter spatially separates the individual input optical signals for reflection along different paths in the prism or reflector. Similarly, in reverse, when the optical system includes a polarization splitter, the splitter may act as a combiner to join two or more output optical signals of different polarizations into a combined output optical signal for transmission via a corresponding optical fiber or core thereof.

In various embodiments, each polarized signal split from the input optical signal is rotated via a polarization rotator located between the silicon polarization splitter and a prism (as used in operation 1520 to reflect the optical signals) to adjust the polarization of at least one of the polarized signals. For example, a polarization rotator can equalize the polarization of a first polarized signal and a second polarized signal so that each shares the same polarization when received by the prism, despite having different polarizations when received by the polarization splitter. Similarly, when two output signals with the same polarization are received by the polarization rotator from the prism, the polarization rotator can rotate the polarization of at least one of the polarized signals to have a different polarization when received by the polarization splitter (combiner) to thereby multiplex the two output signals into a single output signal based on polarization differences.

At operation 1520, the prism or reflector receives optical signals at a first surface. Input optical signals (received from an optical fiber) travel from the first surface through the medium of the prism to a reflective surface. Output optical signals (received from a reflective surface) travel from the reflective surface through the medium of the prism to an associated optical fiber. In various embodiments, optical signals may be transmitted to (or received from) one reflective surface in the prism/reflector, or may be transmitted to (or received from) different reflectors that are configured to reflect different wavelengths of light to multiplex or demultiplex signals carried in different wavelength ranges.

Although generally discussed in relation to processing and handling one signal, method 1500 can be applied to operate with multiple signals at once, such as a plurality of optical signals arranged in a two-dimensional array so that each signal is reflected at a non-normal angle of incidence (per operation 1530) into a corresponding lens of the silicon lens array and coupled into a corresponding optical coupler of the silicon photonic interposer (per operations 1530-1550).

At operation 1530, the (at least one) reflective surface reflects the optical signal at a non-normal angle of incidence. The angle of incidence that the reflector reflects optical signals at is configured with the angle or coupling for the coupling structures in the photonic integrated circuit, which is also non-normal. As used herein, the non-normal angle of incidence is specifically chosen to be greater than or less than 90 degrees and is otherwise outside of a tolerance range of a nominally normal or perpendicular angle to the angle of input from the optical fibers or surface of the interposer that the coupling structures are included in. The reflective surface reflects the input optical signals received at an angle of input into the prism from the optical fibers (or polarization splitter) at the non-normal angle of incidence to be received by the coupling structures at the angle of coupling. The reflective surface reflects the output optical signals received at the angle of coupling from the coupling structures at the non-normal angle of incidence to be received by the optical fibers (in some embodiments via a polarization combiner) at an angle normal to the surface that the coupling structures are included in.

In various embodiments using multiple reflective surfaces, method 1500 performs operation 1530 a number of times corresponding to the number of reflective surfaces for signals of different wavelength ranges. For example, a first reflective surface can reflect a first set of signals with wavelengths of a first range while transmitting a second set of signals with wavelengths of a second range to a second reflective surface. This second reflective surface can then receive and reflect the second set of signals.

At operation 1540, a fiber lens array between the prism or reflector and the interposer focuses the optical signals. The lenses in the fiber lens array correspond to the coupling structures in the interposer. For input optical signals, the lenses may change the beam size of the optical signals to match the input requirements of the coupling structures. Similarly, for output optical signals, the lenses may change the beam size of the optical signals to match the input requirements of the optical fibers. Accordingly, the fiber lens array enables mode conversion between the optical fibers and coupling structures so that different beam sizes can be sent and received.

At operation 1550 the coupling structures couple the optical signals with the interposer. For input optical signals, the coupling structures receive the optical signals at the angle of coupling and direct the optical signal into a waveguide within the photonic integrated circuit at an angle normal to the surface of the photonic integrated circuit. For output optical signals, the coupling structures receive the optical signals at the angle of coupling and direct the optical signal into a waveguide within the photonic integrated circuit at an angle normal to the surface of the photonic integrated circuit. In various embodiments, the coupling structures for input (or output) can include various grating couplers.

Once received by the photonic integrated circuit, various demultiplexers can demultiplex signals of different wavelengths from one another for further processing in the photonic integrated circuit.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry or a device is “operable” to perform a function whenever the circuitry or device comprises the necessary hardware and code (if any is necessary) to perform the function, regardless of whether performance of the function is disabled or not enabled (e.g., by a user-configurable setting, factory trim, etc.).

While the present disclosure has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope.

We claim:

1. A system, comprising:
a prism configured to reflect, via a lensed reflecting surface, a plurality of optical signals between a first surface and a second surface at a non-normal angle of incidence;
a photonic interposer including a plurality of grating couplers corresponding to the plurality of optical signals that are arranged in a two-dimensional array and that are optically connected directly to the first surface of the prism; and
a plurality of optical fibers that are arranged in the two-dimensional array and that are optically connected directly to the second surface of the prism.

2. The system of claim 1, wherein the lensed reflecting surface of the prism includes a plurality of lenses matched to the plurality of optical signals.

3. The system of claim 1, wherein the lensed reflecting surface of the prism includes a single lens that reflects each optical signal of the plurality of optical signals between the plurality of optical fibers and the plurality of grating couplers.

4. The system of claim 1, wherein the two-dimensional array defines a quincunx pattern.

5. The system of claim 1, wherein the plurality of optical fibers are arranged in the two-dimensional array and secured to the second surface of the prism via a fiber interface made of silicon.

6. The system of claim 1, wherein the prism is made of silicon.

7. An optical device, comprising:
a photonic interposer including a plurality of grating couplers arranged according to a two-dimensional array and configured to receive a plurality of optical signals at a given angle of reception;
a prism including a reflecting surface configured to reflect the plurality of optical signals between a first surface and a second surface at a non-normal angle of incidence associated with the given angle of reception, wherein the prism is optically connected directly to the photonic interposer;
a fiber interface including a plurality of optical fibers arranged according to the two-dimensional array; and
a fiber lens array, connected between the fiber interface and the prism, including a plurality of fiber lenses corresponding to the plurality of optical fibers, wherein each fiber lens of the plurality of fiber lenses is located at an optical center of a corresponding beam path between the plurality of optical fibers and the plurality of grating couplers.

8. The optical device of claim 7, wherein the reflecting surface of the prism includes a plurality of lenses matched to the plurality of optical signals.

9. The optical device of claim 7, wherein the reflecting surface of the prism includes a single lens that reflects each optical signal of the plurality of optical signals between the plurality of optical fibers and the plurality of grating couplers.

10. The optical device of claim 7, wherein the two-dimensional array defines a quincunx pattern.

11. The optical device of claim 7, wherein the plurality of optical fibers are arranged in the two-dimensional array and secured to the second surface of the prism via a fiber interface made of silicon.

12. The optical device of claim 7, wherein the prism is made of silicon.

13. The optical device of claim 7, wherein the fiber lens array is made of silicon.

14. An optical device, comprising:
a photonic interposer including a plurality of grating couplers arranged according to a two-dimensional array and configured to receive a plurality of optical signals at a given angle of reception;
a prism including a reflecting surface configured to reflect the plurality of optical signals between a first surface and a second surface at a non-normal angle of incidence associated with the given angle of reception;
a fiber interface including a plurality of optical fibers arranged according to the two-dimensional array, wherein the fiber interface is optically connected directly to the prism; and
a fiber lens array, connected between the prism and the photonic interposer, including a plurality of fiber lenses corresponding to the plurality of grating couplers, wherein each fiber lens of the plurality of fiber lenses is located at an optical center of a corresponding beam path between the plurality of optical fibers and the plurality of grating couplers.

15. The optical device of claim 14, wherein the reflecting surface of the prism includes a plurality of lenses matched to the plurality of optical signals.

16. The optical device of claim 14, wherein the reflecting surface of the prism includes a single lens that reflects each optical signal of the plurality of optical signals between the plurality of optical fibers and the plurality of grating couplers.

17. The optical device of claim 14, wherein the two-dimensional array defines a quincunx pattern.

18. The optical device of claim 14, wherein the plurality of optical fibers are arranged in the two-dimensional array and secured to the second surface of the prism via a fiber interface made of silicon.

19. The optical device of claim 14, wherein the prism is made of silicon.

20. The optical device of claim 14, wherein the fiber lens array is made of silicon.
